(19) United States
(12) Patent Application Publication
(10) Pub. No.: US 2023/0018505 A1
(43) Pub. Date: Jan. 19, 2023

(54) Films Made of Polyethylene Blends for Improved Sealing Performance and Mechanical Properties

(71) Applicant: ExxonMobil Chemical Patents Inc., Baytown, TX (US)

(72) Inventors: Zhi-Yi SHEN, Shanghai (CN); Jiao X. MU, Shanghai (CN); Yuan MEI, Shanghai (CN)

(21) Appl. No.: 17/756,380

(22) PCT Filed: Nov. 19, 2020
(86) PCT No.: PCT/US2020/016130

§ 371 Date: May 24, 2022

Related U.S. Application Data
(60) Provisional application No. 62/949,257, filed on Dec. 17, 2019.

(51) Int. Cl. C08L 23/06; B32B 27/32; B32B 27/08

(52) U.S. Cl. CPC C08L 23/06; B32B 27/32; B32B 27/08; B32B 2307/31; B32B 2307/72; B32B 2270/00; B32B 2307/732; B32B 2307/558; B32B 2307/5825; B32B 2250/242; B32B 2250/03; B32B 2553/00

(57) ABSTRACT

Provided herein are films comprising a core layer sandwiched between an outer layer and a scaling layer. The film has a seal initiation temperature at 5 N/15 mm between about 82° C. and about 88° C., a 1% secant modulus m MD between about 300 MPa and about 400 MPa, and plateau seal strength at between about 16 and about 17 N/15 mm. While the outer layer and core layers comprise polyethylene compositions, the sealing layer comprises a polyethylene blend. The polyethylene blend comprises a plastomer and a polyethylene composition in an amount equal to or less than 50 wt %.

### CROSS REFERENCE TO RELATED APPLICATIONS

This application claims the benefit of U.S. Provisional Application 62/949,257, filed Dec. 17, 2019, entitled “Films Made of Polyethylene Blends for Improved Sealing Performance and Mechanical Properties”, the entirety of which is incorporated by reference therein.

### FIELD OF THE INVENTION

The present disclosure relates to polyethylene blends, and more particularly relates to blown films comprising polyethylene blends of polyethylene compositions and plastomers.

### BACKGROUND OF THE INVENTION

Metallocene-catalyzed plastomers made from solution processes can offer excellent sealing performance in high-performance flexible packaging films while also providing low seal initiation temperature (“SIT”), high hot tack, and good seal strength over a broad temperature window. As such, plastomers can improve the packaging efficiency of fast online packaging, such as vertical form-fill-seal (VFFS) packaging. However, plastomers, ethylene alpha olefin copolymers in solution, are significantly more expensive compared to polyethylene compositions. Therefore, the ethylene alpha olefin copolymer solution can be blended with a polyethylene composition (such as linear low density polyethylene) to achieve a cost-performance balance.

However, while low seal initiation temperature is the key consideration for the fast packaging line, machinability is important for high performance packaging and processability on high-speed automatic packaging equipment. With a fixed film gauge and coefficient of friction (“COF”), machinability is mainly governed by modulus of the film. The higher film modulus is beneficial to the packaging process. Moreover, stiffer films with higher modulus are good for printing as it can withstand the high tension during the printing process and resist deformation.

Blending low density compositions with higher density compositions can increase the modulus of the film and SIT but degrade the mechanical properties, such as dart impact, an important indicator for the toughness of the film. So, the challenge is to meet each of the requirements: low SIT, high modulus as well as high toughness of the film having a blended composition.

A need exists, therefore, for films made of polyethylene compositions having low seal initiation temperature, high modulus, and high toughness.

### SUMMARY OF THE INVENTION

Provided herein are films comprising a core layer sandwiched between an outer layer and a sealing layer. The sealing layer comprises a polyethylene blend. The polyethylene blend comprises a polyethylene composition in an amount from 0% to 100% and a plastomer. The film has a seal initiation temperature at 5.0 N/15 mm between about 75° C. and about 120° C., a 1% secant modulus in MD between about 50 MPa and about 550 MPa, and plateau seal strength at between about 10 and about 20 N/15 mm.

In an aspect, the polyethylene composition has a density between about 0.912 g/cm³ and about 0.930 g/cm³ and an MI (I₂) between about 0.2 g/10 min and about 5 g/10 min. In an aspect, the plastomer is an ethylene alpha olefin copolymer solution. In an aspect, the plastomer is an ethylene-butene copolymer solution. In an aspect, the plastomer is an ethylene-hexene copolymer solution. In an aspect, the plastomer is an ethylene-octene copolymer solution. In an aspect, the film has a layer ratio of about 1/1/1 to about 1/8/1.

Also provided are films comprising a polyethylene blend. The polyethylene blend comprises a plastomer and a polyethylene composition in an amount equal or less than about 50 w-t %. The polyethylene composition has a density between about 0.914 and about 0.920 g/cm³ and a MI of between about 0.5 and 2.0 g/10 min. The polyethylene blend has a density between about 0.88 and about 0.91 g/cm. The film has a seal initiation temperature at 5N of about 80° C. to about 110° C.

Further provided are films comprising a polyethylene blend having a plastomer, and a polyethylene composition in an amount between about 20 wt % and 80 wt %. The polyethylene composition has a density between about 0.916 and about 0.918 g/cm³ and a MI between about 0.2 and about 1 g/10 min. The film has an MD 1% secant modulus between about 60 MPa and about 250 MPa.

In addition, the present films comprise a polyethylene blend comprising a plastomer in an amount between about 20 wt % and 80 wt % and a polyethylene composition having a density between about 0.916 and about 0.918 g/cm³ and a MI of between about 0.2 and about 1 g/10 min. The dart impact of the film is between about 400 grams and about 1,500 grams.

In an aspect, the polyethylene blend comprises a metallocene catalyzed ethylene-octene copolymer and a polyethylene composition having a density between about 0.916 and about 0.918 g/cm³ and a MI between about 0.2 g/10 min and about 1 g/10 min. The polyethylene blend comprises the polyethylene composition in an amount between about 20 wt %, and 80 wt %. The film has an MD Elmendorf tear strength of between about 3 g/μm and about 18 g/μm.

In an aspect, the outer or core layer comprises a polyethylene composition having a density of about 0.918 to about 0.940 g/cm³ and an MI (I₂) of about 0.2 to about 3 g/10 min. In an aspect, the sealing layer has a seal initiation temperature at 5.0 N/15 mm between about 82° C. and about 115° C. In an aspect, the film has 1% secant modulus in MD between about 60 MPa and about 500 MPa. In an aspect, the film has a dart impact between about 100 g and about 2,000 g. In an aspect, the sealing layer has a thickness between about 25 microns and about 150 microns. In an aspect, the sealing layer has a thickness between about 6 and about 50 microns. In an aspect, the film has an Elmendorf tear in MD between about 2 g/micron and about 18 g/micron.

### BRIEF DESCRIPTION OF THE DRAWINGS

FIG. 1 shows heat seal curves of 50 micron EXCEED XP™ mono-layer films.

FIG. 2 provides heat seal curves of 60 micron 3-layer film having a sealing layer comprising polyethylene blends of 75 wt % polyethylene composition (EXCEED XP™ 8358, EXCEED XP™ 6026 AND EXCEED XP™ 6056) and 25 wt % ethylene alpha olefin copolymer solution, EXACT 9182.

FIG. 3 shows heat seal curves for 50 micron films, each comprising a polyethylene blend of an ethylene alpha olefin copolymer solution AFFINITY 1880G and a polyethylene composition, EXCEED XP™ 8656ML.

FIG. 4 shows 1% secant modulus in MD as a function of EXCEED XP™ 8656ML content of mono-layer films having a thickness of 25, 50, and 100 microns and made of polyethylene blends having different blending ratios of the polyethylene composition, EXCEED XP™ 8656 and ethylene alpha olefin copolymer solution, AFFINITY 1880G.

FIG. 5 shows dart impact of mono-layer films having a thickness of 25 and 50 microns and made of polyethylene blends having different blending ratios of the polyethylene composition, EXCEED XP™ 8656 and the ethylene alpha olefin copolymer solution, AFFINITY 1880G.

FIG. 6 shows Elmendorf tear in MD of mono-layer films of having a thickness of 25, 50, and 100 microns and comprising polyethylene blends having different blending ratios of the polyethylene composition, EXCEED XP™ 8656 and the ethylene alpha olefin copolymer solution. AFFINITY 1880G.

### DESCRIPTION OF THE PREFERRED EMBODIMENTS

Before the present compounds, components, compositions, and/or methods are disclosed and described, it is to be understood that unless otherwise indicated this invention is not limited to specific compounds, components, compositions, reactants, reaction conditions, ligands, catalyst structures, metallocene structures, or the like, as such may vary, unless otherwise specified. It is also to be understood that the terminology used herein is for the purpose of describing particular embodiments only and is not intended to be limiting.

For the purposes of this disclosure, the following definitions will apply:

As used herein, the terms “a” and “the” as used herein are understood to encompass the plural as well as the singular.

The term “alpha-olefin” or “α-olefin” refers to an olefin having a terminal carbon-to-carbon double bond in the structure thereof (R¹R²)—C═CH₂, where R¹ and R² can be independently hydrogen or any hydrocarbyl group. In an aspect, R¹ is hydrogen, and R² is an alkyl group. A “linear alpha-olefin” is an alpha-olefin as defined in this paragraph wherein R¹ is hydrogen, and R² is hydrogen or a linear alkyl group.

The term “average” when used to describe a physical property measured in multiple directions, means the average value of the property in each direction. For example, secant modulus can be measured by straining an object in the machine direction (“MD”) or in the transverse direction (“TD”). The “average MD/TD 1% secant modulus” or “average 1% secant modulus” thus refers to the average of the MD secant modulus and the TD secant modulus at 1% strain.

The term “broad orthogonal comonomer distribution” (“BOCD”) is used herein to mean across the molecular weight range of the ethylene polymer, comonomer contents for the various polymer fractions are not substantially uniform and a higher molecular weight fraction thereof generally has a higher comonomer content than that of a lower molecular weight fraction. Both a substantially uniform and an orthogonal comonomer distribution may be determined using fractionation techniques such as gel permeation chromatography-differential viscometry (“GPC-DV”), temperature rising elution fraction-differential viscometry (TREF-DV) or cross-fractionation techniques.

A “catalyst system” as used herein may include one or more polymerization catalysts, activators, supports/carriers, or any combination thereof.

The terms “catalyst system” and “catalyst” are used interchangeably herein.

As used herein, the term “comonomer” refers to the unique mer units in a copolymer. Since comonomers in a copolymer have non-identical MWDs, the composition of the copolymer varies at different molecular weights. As with MWD, comonomer composition must be represented as a distribution rather than as a single value. The term “composition distribution.” or “comonomer distribution.” is a measure of the spread of a copolymer's comonomer composition. Composition distribution is typically characterized as “broad” or “narrow.”

The term “composition distribution breadth index” (“CDBI”) refers to the weight percent of the copolymer molecules having a comonomer content within 50% of the median total molar comonomer content. The CDBI of any copolymer is determined utilizing known techniques for isolating individual fractions of a sample of the copolymer. Exemplary is Temperature Rising Elution Fraction (“TREF”) described in Wild, L. et al. (1982) “Determination of Branching Distributions in Polyethylene and Ethylene Copolymers” J. Poly. Sci., Poly. Phys. Ed., v.20, pg. 441-455 and U.S. Pat. No. 5,008,204.

As used herein, the term “copolymer” refers to polymers having more than one type of monomer, including interpolymers, terpolymers, or higher order polymers.

The term “Cₙ group” or “Cₙ compound” refers to a group or a compound with total number carbon atoms “n.” Thus, a Cₘ-Cₙ group or compound refers to a group or a compound having total number of carbon atoms in a range from m to n. For example, a C₁-C₅₀ alkyl group refers to an alkyl compound having 1 to 50 carbon atoms.

As used herein, the terms “cyclopentadiene” and “cyclopentadienyl” are abbreviated as “Cp.”

All numerical values within the detailed description and the claims herein are modified by “about” or “approximately” the indicated value, taking into account experimental error and variations.

Unless otherwise specified, the term “density” refers to the density of the polyethylene composition or polyethylene blend independent of any additives, such as antiblocks, which may change the tested value.

As used herein, in reference to Periodic Table Groups of Elements, the “new” numbering scheme for the Periodic Table Groups are used as in the David R. Lide ed. (2000) CRC Handbook of Chemistry and Physics (CRC Press 81^{st} ed.).

As used herein, the term “seal initiation temperature” or “SIT” means the temperature at which a heat seal forms immediately after the sealing operation, the strength of the heat seal being measured at a specified time interval (milliseconds) after completion of the sealing cycle and after the seal has cooled to ambient temperature and reached maximum strength. The strength of the seal is often specified—for example, the “seal initiation temperature at 5 N” refers to the temperature at which a seal is formed that will have a strength of 5 N after cooling. Seal initiation temperature can be measured by ASTM F1921.

As used herein, the term “linear low density polyethylene” (“LLDPE”) means polyethylene having a significant number of short branches. LLDPEs can be distinguished structurally from conventional LDPEs because LLDPEs typically have minimal long chain branching and more short chain branching than LDPEs.

The term “metallocene catalyzed linear low density polyethylene” (“mLLDPE”) refers to an LLDPE composition produced with a metallocene catalyst.

The term “linear medium density polyethylene” (“MDPE”) refers to a polyethylene having a density from about 0.930 g/cm³ to about 0.950 g/cm³.

As used herein, the term “metallocene catalyst” refers to a catalyst having at least one transition metal compound containing one or more substituted or unsubstituted Cp moiety (typically two Cp moieties) in combination with a Group 4, 5, or 6 transition metal. A metallocene catalyst is considered a single site catalyst. Metallocene catalysts generally require activation with a suitable co-catalyst, or activator, in order to yield an “active metallocene catalyst”, i.e., an organometallic complex with a vacant coordination site that can coordinate, insert, and polymerize olefins. Active catalyst systems generally include not only the metallocene complex, but also an activator, such as an alumoxane or a derivative thereof (preferably methyl alumoxane), an ionizing activator, a Lewis acid, or a combination thereof. Alkylalumoxanes (typically methyl alumoxane and modified methylalumoxanes) are particularly suitable as catalyst activators. The catalyst system can be supported on a carrier, typically an inorganic oxide or chloride or a resinous material such as, for example, polyethylene or silica. When used in relation to metallocene catalysts, the term “substituted” means that a hydrogen group has been replaced with a hydrocarbyl group, a heteroatom, or a heteroatom containing group. For example, methylcyclopentadiene is a Cp group substituted with a methyl group.

The term “melt index” (“MI”) is the number of grams extruded in 10 minutes under the action of a standard load and is an inverse measure of viscosity. A high MI implies low viscosity and a low MI implies high viscosity. In addition, polymers are shear thinning, which means that their resistance to flow decreases as the shear rate increases. This is due to molecular alignments in the direction of flow and disentanglements.

As provided herein, MI (I₂) is determined according to ASTM D-1238-E (190° C./2.16 kg), also sometimes referred to as I₂ or I_{2.16}.

The “melt index ratio” (“MIR”) provides an indication of the amount of shear thinning behavior of the polymer and is a parameter that can be correlated to the overall polymer mixture molecular weight distribution data obtained separately by using Gel Permeation Chromatography (“GPC”) and possibly in combination with another polymer analysis including TREF. MIR is the ratio of I₂₁/I₂.

The term “melt strength” is a measure of the extensional viscosity and is representative of the maximum tension that can be applied to the melt without breaking. Extensional viscosity is the polyethylene composition's ability to resist thinning at high draw rates and high draw ratios. In melt processing of polyolefins, the melt strength is defined by two key characteristics that can be quantified in process-related terms and in rheological terms. In extrusion blow molding and melt phase thermoforming, a branched polyolefin of the appropriate molecular weight can support the weight of the fully melted sheet or extruded portion prior to the forming stage. This behavior is sometimes referred to as sag resistance.

As used herein, “Mₙ” is number average molecular weight, “M_{w}” is weight average molecular weight, and “M_{z}” is z-average molecular weight. Unless otherwise noted, all molecular weight units (e.g., M_{w}, Mₙ, M_{L}) including molecular weight data are in the unit of g·mol⁻¹.

As used herein, unless specified otherwise, percent by mole is expressed as “mole %,” and percent by weight is expressed as “wt %.”

Molecular weight distribution (“MWD”) is a measure of the spread of a polymer's molecular weight. A given polymer sample comprises molecules of varying chain length, and thus molecular weight, so the molecular weight of a polymer is represented as a distribution rather than as a single value. MWD is typically characterized as “broad” or “narrow.” MWD is equivalent to the expression M_{w}/Mₙ and is also referred to as polydispersity index (“PDI”). The expression M_{w}/Mₙ is the ratio of M_{w}, to Mₙ. M_{w} is given by

$${M}_{w} = \frac{{\sum }_{i} {n}_{i} {M}_{i}^{2}}{{\sum }_{i} {n}_{i} {M}_{i}} ,$$

Mₙ is given by

$${M}_{n} = \frac{{\sum }_{i} {n}_{i} {M}_{i}}{{\sum }_{i} {n}_{i}} ,$$

M_{z} is given by

$${M}_{z} = \frac{{\sum }_{i} {n}_{i} {M}_{i}^{3}}{{\sum }_{i} {n}_{i} {M}_{i}^{2}} ,$$

where nᵢ in the foregoing equations is the number fraction of molecules of molecular weight Mᵢ. Measurements of M_{w}, M_{z}, and Mₙ are typically determined by “Gel Permeation Chromatography,” as disclosed in Macromolecules, v.34(19), pg. 6812 (2001). The measurements proceed as follows. Gel Permeation Chromatography (Agilent PL-220), equipped with three in-line detectors, a differential refractive index detector (“DRI”), a light scattering (LS) detector, and a viscometer, is used. Experimental details, including detector calibration, are described in: Sun, T. et al. (2001) “Effect of Short Chain Branching on the Coil Dimensions of Polyolefins in Dilute Solution” Macromolecules, v.34(19), pp. 6812-6820, (2001). Three Agilent PLgel 10 μm Mixed-B LS columns are used. The nominal flow rate is 0.5 mL/min, and the nominal injection volume is 300 μL. The various transfer lines, columns, viscometer and differential refractometer (the DRI detector) are contained in an oven maintained at 145° C. Solvent for the experiment is prepared by dissolving 6 grams of butylated hydroxytoluene as an antioxidant in 4 liters of Aldrich reagent grade 1,2,4-trichlorobenzene (TCB). The TCB mixture is then filtered through a 0.1 μm Teflon filter. The TCB is then degassed with an online degasser before entering the GPC-3D. Polymer solutions are prepared by placing dry polymer in a glass container, adding the desired amount of TCB, then heating the mixture at 160° C. with continuous shaking for about 2 hours. All quantities are measured gravimetrically. The TCB densities used to express the polymer concentration in mass/volume units are about 1.463 g/ml at about 21° C. and about 1.284 g/ml at about 145° C. The injection concentration is from 0.5 to 2.0 mg/ml, with lower concentrations being used for higher molecular weight samples. Prior to running each sample, the DRI detector and the viscometer are purged. The flow rate in the apparatus is then increased to 0.5 ml/minute, and the DRI is allowed to stabilize for 8 hours before injecting the first sample. The LS laser is turned on at least 1 to 1.5 hours before running the samples. The concentration, c, at each point in the chromatogram is calculated from the baseline-subtracted DRI signal. I_{DRI}, using the following equation.

c=K_{DRI}I_{DRI}/(dn/dc).

where K_{DRI} is a constant determined by calibrating the DRI, and (dn/dc) is the refractive index increment for the system. The refractive index, n=1.500 for TCB at 145° C. Units on parameters throughout this description of the GPC-3D method are such that concentration is expressed in g/cm³, molecular weight is expressed in g/mole, and intrinsic viscosity is expressed in dL/g.

The LS detector is a Wyatt Technology High Temperature DAWN HELEOS. The molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the DRI analysis, A₂ is the second virial coefficient. P(θ) is the form factor for a monodisperse random coil, and K₀ is the optical constant for the system:

$${K}_{o} = \frac{4 {π}^{2} {{n}^{2} ( dn / dc )}^{2}}{{λ}^{4} {N}_{A}} ,$$

where N_{A} is Avogadro's number, and (dn/dc) is the refractive index increment for the system, which take the same value as the one obtained from DRI method. The refractive index, n=1.500 for TCB at 145° C. and λ=657 nm. A high temperature Viscotek Corporation viscometer, which has four capillaries arranged in a Wheatstone bridge configuration with two pressure transducers, can be used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the following equation:

η_{S}=c[η]+0.3(c[η])²,

where c is concentration and was determined from the DRI output.

The branching index (g′ᵥᵢₛ) is calculated using the output of the GPC-DRI-LS-VIS method as follows. The average intrinsic viscosity, [η]_{avg} of the sample is calculated by:

$${[ η ]}_{a ν g} = \frac{\sum {{c}_{i} [ η ]}_{i}}{\sum {c}_{i}} ,$$

where the summations are over the chromatographic slices, i, between the integration limits.

The branching index g′ᵥᵢₛ is defined as:

$${g}^{′} vis = \frac{{[ η ]}_{avg}}{{kM}_{v}^{α}} .$$

M_{V} is the viscosity-average molecular weight based on molecular weights determined by LS analysis. Z average branching index (g′_{Zave}) is calculated using Ci=polymer concentration in the slice i in the polymer peak times the mass of the slice squared, Mi². All molecular weights are weight average unless otherwise noted. All molecular weights are reported in g/mol unless otherwise noted. This method is the preferred method of measurement and used in the examples and throughout the disclosures unless otherwise specified. See also, Sun, T. et al. (2001) “Effect of Short Chain Branching on the Coil Dimensions of Polyolefins in Dilute Solution,” Macromolecules, v.34(19), pg. 6812-6820.

As used herein, the term “olefin” refers to a linear, branched, or cyclic compound comprising carbon and hydrogen and having a hydrocarbon chain containing at least one carbon-to-carbon double bond in the structure thereof, where the carbon-to-carbon double bond does not constitute a part of an aromatic ring. The term olefin includes all structural isomeric forms of olefins, unless it is specified to mean a single isomer or the context clearly indicates otherwise.

As used herein, the term “polymer” refers to a compound having two or more of the same or different “mer” units. A “homopolymer” is a polymer having mer units that are the same. A “copolymer” is a polymer having two or more mer units that are different from each other. A “terpolymer” is a polymer having three mer units that are different from each other. “Different” in reference to mer units indicates that the mer units differ from each other by at least one atom or are different isomerically.

As used herein, when a polymer or copolymer is referred to as comprising an olefin, the olefin present in such polymer or copolymer is the polymerized form of the olefin. For example, when a copolymer is said to have a “propylene” content of 35 wt % to 55 wt %, it is understood that the mer unit in the copolymer is derived from propylene in the polymerization reaction and said derived units are present at 35 wt % to 55 wt %, based upon the weight of the copolymer. A copolymer can be terpolymers and the like.

The term “plastomer” means an ethylene alpha olefin copolymer having rubber-like properties and the processability of plastics. Plastomers are used as polymer modifiers to provide unique properties in flexible packaging molded and extruded products and foamed compounds. In an aspect, plastomers are metallocene-catalyzed α-olefin copolymer in solution having a density between about 0.870 g/cm³ and about 0.920 g/cm³.

The term “plateau seal strength” refers to the maximum seal strength of a film.

As used herein, the terms “polymerization temperature” and “reactor temperature” are interchangeable.

The term “substantially uniform comonomer distribution” is used herein to mean that comonomer content of the polymer fractions across the molecular weight range of the ethylene-based polymer vary by <10.0 wt %. In an aspect, a substantially uniform comonomer distribution refers to <8.0 wt %, <5.0 wt %, or <2.0 wt %.

As used herein, the term “supported” refers to one or more compounds that are deposited on, contacted with, vaporized with, bonded to, incorporated within, adsorbed or absorbed in, or on, a support or carrier. The terms “support” and “carrier” can be used interchangeably and include any support material including, but not limited to, a porous support material or inorganic or organic support materials. Non-limiting examples of inorganic support materials include inorganic oxides and inorganic chlorides. Other carriers include resinous support materials such as polystyrene, functionalized or crosslinked organic supports, such as polystyrene, divinyl benzene, polyolefins, or polymeric compounds, zeolites, talc, clays, or any other organic or inorganic support material and the like, or mixtures thereof.

In an extrusion process, “viscosity” is a measure of resistance to shearing flow. Shearing is the motion of a fluid, layer-by-layer, like a deck of cards. When polymers flow through straight tubes or channels, the polymers are sheared and resistance is expressed in terms of viscosity.

“Extensional” or “elongational viscosity” is the resistance to stretching. In fiber spinning, film blowing and other processes where molten polymers are stretched, the elongational viscosity plays a role. For example, for certain liquids, the resistance to stretching can be three times larger than in shearing. For some polymeric liquids, the elongational viscosity can increase (tension stiffening) with the rate, although the shear viscosity decreased.

As used herein, the “bending stiffness” is a measure of the resistance of film deformation when bent, and can be calculated the by following equation:

$${S}_{b} = \frac{M}{{b ( 1 / R )}^{′}}$$

where S_{b} is the bending stiffness, measured in mN*mm, M is the moment width, b is the width, and R is the radius of the curvature. Bending stiffness can be measured by applying opposing forces at various points on a beam and measuring the resulting curvature of the beam. For example, in the 3-point method, force is applied in one direction on the ends and in the opposite direction in the center, and the resulting radius of the curvature is measured.

Various measurements described herein may be based on certain standardized testing procedures. For example, measurements of tensile strength in the machine direction (MD) and transverse direction (TD) can be made by following the procedure of ASTM D882. Measurements of yield strength in MD and TD can be made by following the procedure of ASTM D882. Measurements of Elmendorf tear strength in MD and TD can be made by following the procedure of ASTM D1922-09. Measurements for 1% secant modulus can be made by following the procedure of ASTM D790A. Measurements for puncture peak force and puncture break energy can be made by following the procedure of ASTM F1306. Measurements of dart impact (also known as “dart drop” or “dart drop impact”) can be made using ISO 7765-1, method “A”. Gloss measurements in MD and TD can be made by following the procedure of ASTM D523. Light transmission percent (or haze) measurements can be made by following the procedure of ASTM D1003 using a haze meter Haze-Guard Plus AT-4725 from BYK Gardner and defined as the percentage of transmitted light passing through the bulk of the film sample that is deflected by more than 2.5°.

The “secant modulus” is the slope of a line connecting the origin to an object's stress/strain curve at a specified strain percentage. For example, the “1% secant modulus” is the slope of a line connecting the origin to an object's stress/strain curve at 1% strain. The secant modulus describes the overall stiffness of an object. Lower strain percentages typically approximate elastic behavior more accurately. Measurements for 1% secant modulus can be made by following the procedure of ASTM D790A.

The term “tensile strength” refers to the stretching force required to inelastically deform a material. The tensile strength of a material can be measured by stretching the material in MD or TD. Tensile strength is measured in psi and can be tested via ASTM D882.

Provided herein are films comprising a sealing layer made from a polyethylene blend. As described herein, the polyethylene blend comprises a plastomer in an amount between 20 wt % and 80 wt % and a polyethylene composition having a density between about 0.912 g/cm³ and about 0.930 g/cm³ and an MI (I₂) between about 0.2 g/10 min and about 5 g/10 min. In an aspect, the polyethylene blend comprises the polyethylene composition in an amount between about 0 to about 100 wt % or equal to or less than 50 wt %.

As described in the examples below, the films can comprise an outer layer, a core layer, and the sealing layer. The core layer is sandwiched between the outer layer and the sealing layer. Both the outer layer and the core layers comprise one or more polyethylene compositions described herein. In an aspect, the outer layer can comprise a polyethylene composition having a density of about 0.920 g/cm³ and an MI (I₂) of about 0.5 g/10 mm. In an aspect, the core layer can comprise a polyethylene composition having a density of about 0.918 to about 0.940 g/cm³ and an MI (I₂) of about 0.2 to about 3 g/10 min. The film can have a thickness between about 25 microns and about 100 microns. The present films have a 1% secant modulus in MD between about 50 MPa and about 550 MPa, between about 275 MPa and about 400 MPa, between about 295 MPa and 375 MPa, between about 300 MPa and about 360 MPa. The subject films have a seal initiation temperature at 5 N/15 mm between about 75° C. and about 120° C., between about 82° C. and about 88° C., between about 80° C. and about 110° C., about 85° C. and about 88° C., and between about 86° C. and about 87° C. In an aspect, the subject films have a variety of layer ratios including from about 1/1/1 to about 1/8/1. Also, the subject films have a plateau seal strength (N/15 mm) between about 10 and about 20, about 15 and about 19, between about 15 and about 17, and between about 15 and 16.

In an aspect, the sealing layers provided herein have a seal initiation temperature at 5 N/15 mm between about 82° C. and about 115° C.; between about 75° C. and about 120° C., between about 85° C. and about 115° C., between about 80° C. and about 110°, and between about 95° C. and 105° C. In an aspect, the film has an Elmendorf tear in MD between about 5 g/micron and about 20 g/micron, and more particularly between about 6 g/micron and 15 g/micron.

### Polyethylene Compositions

As described herein, the present polyethylene compositions comprise from about 50.0 mol % to about 100.0 mol % of units derived from ethylene. The lower limit on the range of ethylene content can be from 50.0 mol %, 75.0 mol %, 80.0 mol %, 85.0 mol. %, 90.0 mol %, 92.0 mol %, 94.0 mol %, 95.0 mol %, 96.0 mol %, 97.0 mol %, 98.0 mol %, or 99.0 mol % based on the mol % of polymer units derived from ethylene. The polyethylene composition can have an upper limit on the range of ethylene content of 80.0 mol %, 85.0 mol %, 90.0 mol %, 92.0 mol %, 94.0 mol %, 95.0 mol %, 96.0 mol %, 97.0 mol %, 98.0 mol %, 99.0 mol %, 99.5 mol %, or 100.0 mol %, based on mole % of polymer units derived from ethylene.

Further provided herein are polyethylene compositions produced by polymerization of ethylene and, optionally, an alpha-olefin comonomer having from 3 to 10 carbon atoms. Alpha-olefin comonomers are selected from monomers having 3 to 10 carbon atoms, such as C₃-C₁₀ alpha-olefins. Alpha-olefin comonomers can be linear or branched or may include two unsaturated carbon-carbon bonds, i.e., dienes. Examples of suitable comonomers include linear C₃-C₁₀ alpha-olefins and alpha-olefins having one or more C₁-C₃ alkyl branches or an aryl group. Comonomer examples include propylene, 1-butene, 3-methyl-1-butene, 3,3-dimethyl-1-butene, 1-pentene, 1-pentene with one or more methyl, ethyl, or propyl substituents, 1-hexene, 1-hexene with one or more methyl, ethyl, or propyl substituents, 1-heptene, 1-heptene with one or more methyl, ethyl, or propyl substituents, 1-octene, 1-octene with one or more methyl, ethyl, or propyl substituents, 1-nonene, 1-nonene with one or more methyl, ethyl, or propyl substituents, ethyl, methyl, or dimethyl-substituted 1-decene, 1-dodecene, and styrene.

Exemplary combinations of ethylene and comonomers include: ethylene 1-butene, ethylene 1-pentene, ethylene 4-methyl-1-pentene, ethylene 1-hexene, ethylene 1-octene, ethylene decene, ethylene dodecene, ethylene 1-butene 1-hexene, ethylene 1-butene 1-pentene, ethylene 1-butene 4-methyl-1-pentene, ethylene 1-butene 1-octene, ethylene 1-hexene 1-pentene, ethylene 1-hexene 4-methyl-1-pentene, ethylene 1-hexene 1-octene, ethylene 1-hexene decene, ethylene 1-hexene dodecene, ethylene propylene 1-octene, ethylene 1-octene 1-butene, ethylene 1-octene 1-pentene, ethylene 1-octene 4-methyl-1-pentene, ethylene 1-octene 1-hexene, ethylene 1-octene decene, ethylene 1-octene dodecene, and combinations thereof. It should be appreciated that the foregoing list of comonomers and comonomer combinations are merely exemplary and are not intended to be limiting. Often, the comonomer is 1-butene, 1-hexene, or 1-octene.

During copolymerization, monomer feeds are regulated to provide a ratio of ethylene to comonomer, e.g., alpha-olefin, so as to yield a polyethylene having a comonomer content, as a bulk measurement, of from about 0.1 mol. % to about 20 mol % comonomer. In other aspects the comonomer content is from about 0.1 mol % to about 4.0 mol %, or from about 0.1 mol % to about 3.0 mol %, or from about 0.1 mol % to about 2.0 mol %, or from about 0.5 mol % to about 5.0 mol %, or from about 1.0 mol % to about 5.0 mol %. The reaction temperature, monomer residence time, catalyst system component quantities, and molecular weight control agent (such as H₂) may be regulated so as to provide the polyethylene compositions. For linear polyethylenes, the amount of comonomers, comonomer distribution along the polymer backbone, and comonomer branch length will generally delineate the density range.

Comonomer content is based on the total content of all monomers in the polymer. The polyethylene copolymer has minimal long chain branching (i.e., less than 1.0 long-chain branch/1.000 carbon atoms, particularly 0.05 to 0.50 long-chain branch/1,000 carbon atoms). Such values are characteristic of a linear structure that is consistent with a branching index (as defined below) of g′ᵥᵢₛ≥0.980, 0.985, ≥0.99, ≥0.995, or 1.0. While such values are indicative of little to no long chain branching, some long chain branches can be present (i.e., less than 1.0 long-chain branch/11,000 carbon atoms, or less than 0.5 long-chain branch/1,000 carbon atoms, particularly 0.05 to 0.50 long-chain branch/1,000 carbon atoms).

Generally, polyethylene can be polymerized in any catalytic polymerization process, including solution phase processes, gas phase processes, slurry phase processes, and combinations of such processes. An exemplary process used to polymerize ethylene-based polymers, such as LLDPEs, is as described in U.S. Pat. Nos. 6,936,675 and 6,528,597.

The above-described processes can be tailored to achieve desired polyethylene compositions. For example, comonomer to ethylene concentration or flow rate ratios are commonly used to control composition density. Similarly, hydrogen to ethylene concentrations or flow rate ratios are commonly used to control composition molecular weight.

Polyethylene compositions provided herein can be blended with LLDPE and other polymers, such as additional polymers prepared from ethylene monomers. Exemplary additional polymers are LLDPE, non-linear LDPE, very low density polyethylene (“VLDPE”), MDPE, high density polyethylene (“HDPE”), differentiated polyethylene (“DPE”), and combinations thereof. DPE copolymers include ethylene vinyl acetate (“EVA”), ethylene ethyl acetate (“EEA”), ethylene methyl acetate (“EMA”), ethylene butyl acetate (“EBA”), and other specialty copolymers. The additional polymers contemplated in certain aspects include ethylene homopolymers and/or ethylene-olefin copolymers. The product of blending one or more polyethylene compositions with other polymers is referred to as a polyethylene blend. In an aspect, a polyethylene blend comprises a polyethylene composition blended with a plastomer comprising either an ethylene-butene copolymer or an ethylene-octene copolymer.

Polyethylene compositions can be composed of blended polymers and include at least 0.1 wt % and up to 99.9 wt % of LLDPE, and at least 0.1 wt % and up to 99.9 wt % of one or more additional polymers, with these wt % based on the total weight of the polyethylene composition. Alternative lower limits of LLDPE can be 5%, 10%, 20%, 30%, 40%, or 50% by weight. Alternative upper limits of LLDPE can be 95%, 90%, 80%, 70%, 60%, and 50% by weight. Ranges from any lower limit to any upper limit are within the scope of the invention. Preferred blends include more than about 90% LLDPE, and preferably more than about 95% LLDPE. In an aspect, the blends include from 5-85%, alternatively from 10-50% or from 10-30% by weight of LLDPE. The balance of the weight percentage is the weight of the additional and/or other type of polymers, e.g., different LLDPE, LDPE, VLDPE, MDPE, HDPE, DPE such as EVA, EEA, EMA, EBA, and combinations thereof.

The polyethylene compositions can have a density greater than or equal to (“≥”) about 0.895 g/cm³, ≥about 0.896 g/cm³, ≥about 0.897 g/cm³, ≥about 0.898 g/cm³, ≥about 0.899 g/cm³, ≥about 0.900 g/cm³, ≥about 0.910 g/cm³, ≥about 0.920 g/cm³, 0.930 g/cm³, ≥about 0.935 g/cm³, ≥about 0.940 g/cm³, ≥about 0.945 g/cm³, ≥about 0.950 g/cm³, ≥about 0.955 g/cm³, and ≥about 0.960 g/cm³. Alternatively, polyethylene compositions can have a density less than or equal to (“≤”) about 0.%0 g/cm³ about 0.950 g/cm³, e.g., ≤about 0.940 g/cm³, ≤about 0.930 g/cm³, ≤about 0.920 g/cm³, ≤about 0.910 g/cm³, ≤about 0.900 g/cm³ and ≤about 0.890 g/cm³. These ranges include, but are not limited to, ranges formed by combinations any of the above-enumerated values. e.g., from about 0.895 to about 0.960 g/cm³, about 0.900 to about 0.950 g/cm³, about 0.910 about to 0.940 g/cm³, about 0.935 to about 0.950 g/cm³, etc. Density can be determined using chips cut from plaques compression molded in accordance with ASTM D-1928-C, aged in accordance with ASTM D-618 Procedure A. and measured as specified by ASTM D-1505.

The polyethylene compositions can have an MI (I₂) according to ASTM D-1238-E (190° C./2.16 kg) reported in grams per 10 minutes (g/10 min), of ≥about 0.10 g/10 min, e.g., ≥about 0.15 g/10 min, ≥about 0.18 g/10 min, ≥about 0.20 g/10 min, ≥about 0.22 g/10 min, ≥about 0.25 g/10 min, ≥about 0.28 g/10 min, or ≥about 0.30 g/10 min.

Also, the polyethylene compositions can have an MI≤about 5.0 g/10 min, ≤about 3.0 g/10 min, ≤about 2.0 g/10 min, ≤about 1.5 g/10 min, ≤about 1.0 g/10 min, ≤about 0.75 g/10 min, ≤about 0.50 g/10 min, ≤about 0.40 g/10 min, ≤about 0.30 g/10 min, ≤about 0.25 g/10 min, ≤about 0.22 g/10 min, ≤about 0.20 g/10 min, ≤about 0.18 g/10 min, or ≤about 0.15 g/10 min. The ranges, however, include, but are not limited to, ranges formed by combinations any of the above-enumerated values, for example: from about 0.1 to about 5.0; about 0.2 to about 2.0; and about 0.2 to about 0.5 g/10 min.

The polyethylene compositions can have a melt index ratio (“MIR”) that is a dimensionless number and is the ratio of the high load MI to the MI, or I_{21.6}/I_{2.16}, as described above. The MIR of the polyethylene compositions described herein is from about 25 to about 80, alternatively, from about 25 to about 70, alternatively, from about 30 to about 55, and alternatively, from about 35 to about 50.

The polyethylene compositions can have an orthogonal comonomer distribution. The term “orthogonal comonomer distribution” is used herein to mean across the molecular weight range of the ethylene polymer, comonomer contents for the various polymer fractions are not substantially uniform and a higher molecular weight fraction thereof generally has a higher comonomer content than that of a lower molecular weight fraction. Both a substantially uniform and an orthogonal comonomer distribution may be determined using fractionation techniques such as gel permeation chromatography-differential viscometry (“GPC-DV”), temperature rising elution fraction-differential viscometry (“TREF-DV”) or cross-fractionation techniques.

In an aspect, the polyethylene compositions can have at least a first peak and a second peak in a comonomer distribution analysis, wherein the first peak has a maximum at a log(M_{w}) value of 4.0 to 5.4, 4.3 to 5.0, or 4.5 to 4.7; and a TREF elution temperature of 70.0° C. to 100.0° C., 80.0° C. to 95.0° C., or 85.0° C. to 90.0° C. The second peak in the comonomer distribution analysis has a maximum at a log(M_{w}) value of 5.0 to 6.0, 5.3 to 5.7, or 5.4 to 5.6; and a TREF elution temperature of 5.0° C. to 60.0° C. or 10.0° C. to 60.0° C. A description of the TREF methodology is described in U.S. Pat. No. 8,431,661 B2 and U.S. Pat. No. 6,248,845 B1.

The present polyethylene compositions typically have a broad composition distribution as measured by CDBI or solubility distribution breadth index (“SDBI”). For details of determining the CDBI or SDBI of a copolymer, see, for example, PCT Patent Application WO 1993/003093, published Feb. 18, 1993. Polymers produced using a catalyst system described herein have a CDBI less than 50%, or less than 40%, or less than 30%. In an aspect, the polymers have a CDBI of from 201% to less than 501%. In an aspect, the polymers have a CDBI of from 20% to 35%. In an aspect, the polymers have a CDBI of from 25% to 28%.

Polyethylene compositions are produced using a catalyst system described herein and can have an SDBI greater than 15° C., or greater than 16° C., or greater than 17° C., or greater than 18° C., or greater than 20° C. In an aspect, the polyethylene compositions have an SDBI from 18° C. to 22° C. In an aspect, the polyethylene compositions have an SDBI from 18.7° C. to 21.4° C. In an aspect, the polyethylene compositions have an SDBI from 20° C. to 22° C.

Certain of the present polyethylene compositions are sold under the ENABLE® trademark, including metallocene polyethylene compositions (“Enable® mPE”), which are available from ExxonMobil Chemical Company. ENABLE® mPE polyethylene compositions balance processability and mechanical properties, including tensile strength and elongation to break with advanced drawdown and enhanced pipe rupture (failure) time and toughness. Applications for Enable® products include food packaging, form fill and seal packaging, heavy duty bags, lamination film, stand up pouches, multilayer packaging film, and shrink film.

For example, ENABLE 2005HH polyethylene composition comprises metallocene ethylene 1-hexene copolymers and has a processing aid additive, a thermal stabilizer additive, a density of about 0.920 g/cm³, and an MI (I₂) of about 0.5 g/10 min.

Likewise, ENABLE 3505HH polyethylene composition comprises medium density metallocene ethylene-hexene copolymers and has a processing aid additive, a thermal stabilizer additive, a density of about 0.935 g/cm³, and an MI (I₂) of about 0.5 g/10 min.

Certain of the present polyethylene compositions are sold under the EXCEED XP™ trademark, including metallocene polyethylene compositions (“EXCEED XP™ mPE”), which are available from ExxonMobil Chemical Company. EXCEED XP™ mPE compositions offer step-out performance with respect to, for example, dart drop impact strength, flex-crack resistance, and machine direction (MD) tear, as well as maintaining stiffness at lower densities. EXCEED XP™ mPE compositions also offer optimized solutions for a good balance of melt strength, toughness, stiffness, and sealing capabilities which makes this family of polymers well-suited for blown film/sheet solutions.

For example, EXCEED XP™ 6026ML polyethylene composition comprises LLDPE I-hexene copolymers and has a processing aid additive, a thermal stabilizer additive, a density of about 0.916 g/cm³, and an MI (I₂) of about 0.20 g/10 min.

Likewise, EXCEED XP™ 6056ML polyethylene composition comprises LLDPE 1-hexene copolymer and has a processing aid additive, a thermal stabilizer additive, a density of about 0.916 g/cm³, and an MI (I₂) of about 0.50 g/10 min.

Likewise, EXCEED XP™ 8358ML polyethylene composition comprises ethylene 1-hexene copolymer and has a processing aid additive, a thermal stabilizer additive, a density of about 0.918 g/cm³, and an MI (I₂) of about 0.50 g/10 min.

Likewise, EXCEED XP™ 8656ML polyethylene composition comprises ethylene 1-hexene copolymer and has a processing aid additive, a thermal stabilizer additive, a density of about 0.916 g/cm³, and an MI (I₂) of about 0.50 g/10 min.

EXACT™ 9182 plastomer comprises ethylene-butene copolymers in solution having a density of about 0.885 g/cm³ and an MI (I₂) of about 1.2 g/10 min. available from the ExxonMobil Chemical Company.

AFFINITY 1880G plastomer comprises ethylene-octene copolymers and has a density of about 0.902 g/cm³ and an MI (I₂) of about 1.0 g/10 min, available from the Dow Chemical Company.

### Conventional Catalysts

Conventional catalysts refer to Ziegler Natta catalysts or Phillips-type chromium catalysts. Examples of conventional-type transition metal catalysts are discussed in U.S. Pat. Nos. 4,115,639, 4,077,904 4,482,687, 4,564,605, 4,721,763, 4,879,359 and 4,960,741. The conventional catalyst compounds that may be used in the processes disclosed herein include transition metal compounds from Groups 3 to 10, or Groups 4 to 6 of the Periodic Table of Elements.

These conventional-type transition metal catalysts may be represented by the formula:

MRx

where M is a metal from Groups 3 to 10, or Group 4, or titanium; R is a halogen or a hydrocarbyloxy group; and x is the valence of the metal M. In an aspect, x is 1, 2, 3 or 4, or x is 4. Non-limiting examples of R include alkoxy, phenoxy, bromide, chloride and fluoride. Non-limiting examples of conventional-type transition metal catalysts where M is titanium include TiCl3, TiCl4, TiBr4, Ti(OC2H5)3Cl, Ti(OC2H5)Cl3, Ti(OC4H9)3Cl, Ti(OC3H7)2Cl2, Ti(OC2H5)2Br2, TiCl3.1/3AlCl3 and Ti(OC12H25)Cl3. Conventional chrome catalysts, often referred to as Phillips-type catalysts, may include CrO3, chromocene, silyl chromate, chromyl chloride (CrO2Cl2), chromium-2-ethyl-hexanoate, chromium acetylacetonate (Cr(AcAc)3). Non-limiting examples are disclosed in U.S. Pat. Nos. 2,285,721, 3,242,099 and 3,231,550. For optimization, many conventional-type catalysts require at least one cocatalyst. A detailed discussion of cocatalyst may be found in U.S. Pat. No. 7,858,719, Col. 6, line 46, to Col. 7, line 45.

### Metallocene Catalysts

Metallocene catalysts (also referred to herein sometimes as metallocenes or metallocene compounds) are generally described as containing one or more ligand(s) and one or more leaving group(s) bonded to at least one metal atom, optionally with at least one bridging group. The ligands are generally represented by one or more open, acyclic, or fused ring(s) or ring system(s) or a combination thereof. These ligands, the ring(s) or ring system(s), can comprise one or more atoms selected from Groups 13 to 16 atoms of the Periodic Table of Elements; in an aspect, the atoms are selected from the group consisting of carbon, nitrogen, oxygen, silicon, sulfur, phosphorous, germanium, boron and aluminum or a combination thereof. Further, the ring(s) or ring system(s) comprise carbon atoms such as, but not limited to, those cyclopentadienyl ligands or cyclopentadienyl-type ligand structures or other similar functioning ligand structures such as a pentadiene, a cyclooctatetraendiyl, or an imide ligand. The metal atom can be selected from Groups 3 through 15 and the lanthanide or actinide series of the Periodic Table of Elements. The metal is a transition metal from Groups 4 through 12, Groups 4, 5 and 6, and the transition metal is from Group 4.

Exemplary metallocene catalysts and catalyst systems are described in, for example, U.S. Pat. Nos. 4,530,914, 4,871,705, 4,937,299, 5,017,714, 5,055,438, 5,096,867, 5,120,867, 5,124,418, 5,198,401, 5,210,352, 5,229,478, 5,264.405, 5,278,264, 5,278,119, 5,304,614, 5,324,800, 5,347,025, 5,350,723, 5,384,299, 5,391,790, 5,391,789, 5,399,636, 5,408,017, 5,491.207, 5,455,366, 5,534,473, 5,539,124, 5,554,775, 5,621,126, 5,684,098, 5,693,730, 5,698,634, 5,710,297, 5,712,354, 5,714,427, 5,714,555, 5,728,641, 5,728,839, 5,753,577, 5,767,209, 5,770,753, 5,770,664; EP-A-0 591 756, EP-A-0 520-732, EP-A-0 420 436, EP-B1 0 485 822, EP-B1 0 485 823, EP-A2-0 743 324, EP-B1 0 518 092; WO 1991/004257, WO 1992/000333, WO 1993/008221, WO 1993/008199. WO 1994/001471, WO 1996/020233, WO 1997/015582, WO 1997/019959, WO 1997/046567, WO 1998/001455, WO 1998/006759, and WO 1998/011144.

### Polymerization Processes

The catalysts described above are suitable for use in any olefin pre-polymerization or polymerization process or both. Suitable polymerization processes include solution, gas phase, slurry phase, and a high-pressure process, or any combination thereof. A desirable process is a gas phase polymerization of one or more olefin monomers having from 2 to 30 carbon atoms, from 2 to 12 carbon atoms in an aspect, and from 2 to 8 carbon atoms in an aspect. Other monomers useful in the process include ethylenically unsaturated monomers, diolefins having 4 to 18 carbon atoms, conjugated or nonconjugated dienes, polyenes, vinyl monomers and cyclic olefins. Non-limiting monomers may also include norbomene, norbornadiene, isobutylene, isoprene, vinylbenzocyclobutane, styrenes, alkyl substituted styrene, ethylidene norbomene, dicyclopentadiene and cyclopentene.

In an aspect, a copolymer of ethylene derived units and one or more monomers or comonomers is produced. The one or more comonomers are an α-olefin having from 4 to 15 carbon atoms in an aspect, from 4 to 12 carbon atoms in an aspect, and from 4 to 8 carbon atoms in an aspect. The comonomer can be 1-hexene.

Hydrogen gas is often used in olefin polymerization to control the final properties of the polyolefin, such as described in Polypropylene Handbook 76-78 (Hanser Publishers, 1996). Increasing concentrations (partial pressures) of hydrogen increase the melt flow rate (MFR) and/or MI of the polyolefin generated. The MFR or MI can thus be influenced by the hydrogen concentration. The amount of hydrogen in the polymerization can be expressed as a mole ratio relative to the total polymerizable monomer, for example, ethylene, or a blend of ethylene and hexane or propene. The amount of hydrogen used in the polymerization process is an amount necessary to achieve the desired MFR or MI of the final polyolefin composition. The mole ratio of hydrogen to total monomer (H₂:monomer) is in a range of from greater than 0.0001 in an aspect, from greater than 0.0005 in an aspect, from greater than 0.001 in an aspect, to less than 10 in an aspect, less than 5 in an aspect, less than 3 in an aspect, and less than 0.10 in an aspect, wherein a desirable range may comprise any combination of any upper mole ratio limit with any lower mole ratio limit described herein. Expressed another way, the amount of hydrogen in the reactor at any time may range to up to 5,000 ppm, up to 4,000 ppm in an aspect, up to 3,000 ppm in an aspect, between 50 ppm and 5,000 ppm in an aspect, and between 100 ppm and 2,000 ppm in an aspect.

In a gas phase polymerization process, a continuous cycle is often employed where one part of the cycle of a reactor system, a cycling gas stream, otherwise known as a recycle stream or fluidizing medium, is heated in the reactor by the heat of polymerization. This heat is removed from the recycle composition in another part of the cycle by a cooling system external to the reactor. Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer.

The ethylene partial pressure can vary between 80 and 300 psia, or between 100 and 280 psia, or between 120 and 260 psia, or between 140 and 240 psia. More importantly, a ratio of comonomer to ethylene in the gas phase can vary from 0.0 to 0.10, or between 0.005 and 0.05, or between 0.007 and 0.030, or between 0.01 and 0.02.

Reactor pressure typically varies from 100 psig (690 kPa) to 500 psig (3,448 kPa). In an aspect, the reactor pressure is maintained within the range of from 200 psig (1,379 kPa) to 500 psig (3,448 kPa). In an aspect, the reactor pressure is maintained within the range of from 250 psig (1,724 kPa) to 400 psig (2,759 kPa).

### Production of Blown Film

Blown film extrusion involves the process of extruding the polyethylene blend (also referred to sometimes as a resin) through a die (not shown) followed by a bubble-like expansion. Advantages of manufacturing film in this manner include: (1) a single operation to produce tubing: (2) regulation of film width and thickness by control of the volume of air in the bubble; (3) high extruder output and haul-off speed, (4) elimination of end effects such as edge bead trim and nonuniform temperature that can result from flat die film extrusion; and (5) capability of biaxial orientation (allowing uniformity of mechanical properties).

As part of the process, a melt comprising the polyethylene blend is mixed with a foaming agent and extruded through an annular slit die (not shown) to form a thin walled tube. Air is introduced via a hole in the center of the die to blow up the tube like a balloon. Mounted on top of the die, a high-speed air ring (not shown) blows onto the hot film to cool it. The foam film is drawn in an upward direction, continually cooling, until it passes through nip rolls (not shown) where the tube is flattened to create what is known as a ‘lay-flat’ tube of film. This lay-flat or collapsed tube is then taken back down the extrusion tower (not shown) via more rollers. For high output lines, air inside the bubble may also be exchanged. The lay-flat film is either wound or the edges of the film are slit off to produce two flat film sheets and wound up onto reels to produce a tube of film. For lay-flat film, the tube can be made into bags, for example, by sealing across the width of film and cutting or perforating to make each bag. This operation can be performed either in line with the blown film process or at a later time. The blown film extrusion process is typically a continuous process.

In coextrusion lines, the number of extruders depends on the number of different materials being extruded and not necessarily on the number of layers. Current feedblock technology allows fluid flow from one extruder to be split into two or more layers in the coextrudate. In an aspect, a coextrusion feedblock arranges the different melt streams in a predetermined layer sequence and generates a melt stream for each layer. Each melt stream then meets its neighboring layers and a final planar coextrudate is formed. The coextrusion feedblock can be fixed or have variable geometry blocks. A flat die, and the synergy between the die and the feedblock, are crucial to high quality film production. The die must spread the coextrudate received from the feedblock while maintaining flatness of the film. The die requires a sufficiently short residence time in order to prevent heat transfer between layers or polymer degradation. The die must also be sufficiently strong so as to resist deformation when subjected to high pressures inherent in thin film processes.

It is to be understood that while the invention has been described in conjunction with the specific embodiments thereof, the foregoing description is intended to illustrate and not limit the scope of the invention. Other aspects, advantages, and modifications will be apparent to those skilled in the art to which the invention pertains.

Therefore, the following examples are put forth so as to provide those skilled in the art with a complete disclosure and description and are not intended to limit the scope of that which the inventors regard as their invention.

EXACT™ 9182 and AFFINITY 1880G are ethylene-butene copolymer and ethylene-octene copolymer respectively, both produced from solution processing. As provided herein, the two plastomer grades (also referred to as plastomer solutions) were blended with EXCEED XP™ polyethylene compositions to study the behaviors of the sealing performance and mechanical properties of films produced using the polyethylene blends. Synergy between plastomers and EXCEED XP™ 8000 series polyethylene composition related to the improvement of sealing performance and mechanical properties were found and are described below.

### Example I

In this example, film samples having 3 layers (film structure) with 1/2/1 film layer ratio were produced on Jinming 3-layer coextrusion blown line with die gap 1.5 mm and die diameter 250 mm under normal processing conditions. Three different EXCEED XP™ polyethylene compositions were blended with the ethylene-butene copolymer plastomer EXACT™ 9182 to provide three sealing layers and film formulations shown in Table 1 below.

TABLE 1
Film Formulations

| Sample | Film | | | |
|---|---|---|---|---|
| No. | Gauge | Outer Layer | Core Layer | Sealing Layer |
| EM1 | 60 μm | Enable 2005 | Enable 3505 | 75% Exceed |
| | | | | XP 8358 + 25% |
| | | | | Exact 9182 |
| EM2 | 60 μm | Enable 2005 | Enable 3505 | 75% Exceed |
| | | | | XP 6026 + 25% |
| | | | | Exact 9182 |
| EM3 | 60 μm | Enable 2005 | Enable 3505 | 75% Exceed |
| | | | | XP 6056 + 25% |
| | | | | Exact 9182 |

TABLE 2
Materials Information

| | Ml (g/10 min. | |
|---|---|---|
| Material | 2.16 kg/190° C.) | Density (g/cm³) |
| Exceed XP 8358 | 0.5 | 0.918 |
| Exceed XP 6026 | 0.2 | 0.916 |
| Exceed XP 6056 | 0.5 | 0,916 |
| Exact 9182 | 1.2 | 0.884 |
| Enable 2005 | 0.5 | 0.920 |
| Enable 3505 | 0.5 | 0.935 |

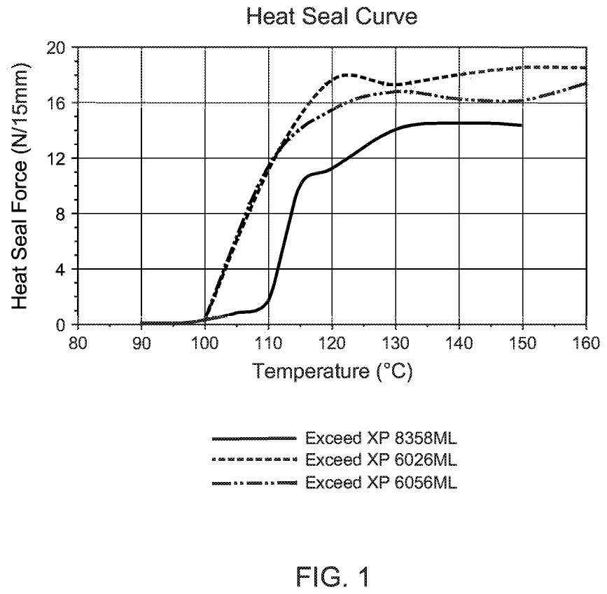

FIG. 1 shows us the heat seal curves for mono-layer film (single layer film) of different polyethylene blends. Each sealing layer comprised a different polyethylene blend of the polyethylene composition. EXCEED™ XP 8358 and the ethylene-butene copolymer plastomer, EXACT™ 9182. Each of the curves shown in FIG. 1 were obtained from 50 μm mono-layer film. The seal initiation temperature (“SIT”) is defined as the temperature at which a 5.0 N/15 mm seal strength is attained. The SIT for the polyethylene compositions EXCEED XP™ 8358, 6026, and 6056 are about 112° C., about 105° C., and about 105° C., respectively. This is consistent with our understanding that a higher density composition will give rise to higher SIT.

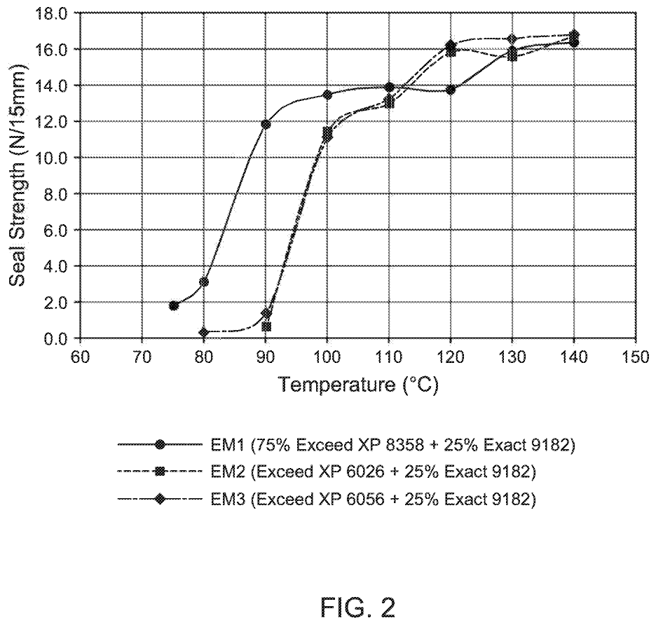

FIG. 2 provides the heat seal curves for 3-layer films comprising different sealing layers. After blending 25% wt % of the ethylene-butene copolymer plastomer EXACT™ 9182 with the polyethylene composition EXCEED XP™ in the sealing layer, each of the three film samples showed lower SIT than that of pure 50 μm mono-layer EXCEED XP™ films listed in Table 1. Noteworthy is that sample EM1 with the sealing layer having 75 wt % of EXCEED XP™ 8358 has almost 10° C. lower SIT than EM 2 and EM3 having a sealing layer comprising the polyethylene compositions EXCEED XP™ 6026 and EXCEED XP™ 6056 based sealing layer. For pure EXCEED XP™ films, EXCEED XP™ 8358 has lower plateau seal strength than EXCEED XP™ 6026 and EXCEED XP™6056, however, 75 wt % EXCEED XP™ 8656 showed two seal plateaus with final plateau seal strength compared with 75 wt % EXCEED XP™ 6026 and EXCEED XP™ 6056.

Table 3 summarizes the SIT and plateau seal strength of three different 3-layer films (EM1, EM2 and EM3 of Table 1 above), where each of the films has a different sealing layer (i.e., a sealing layer made from a different polyethylene blend). As provided in Table 4, EM1 had a slightly higher MD 1% secant modulus indicating that the EM1 film may have higher stiffness.

TABLE 3
SIT and Plateau Seat Strength of 3-Layer Films of Table 1

| Value | EMI | EM2 | EM3 |
|---|---|---|---|
| SIT @ 5.0 N/15 mm (° C.) | 82 | 93 | 93 |
| Plateau Seal Strength (N/15 mm) | 16 | 16 | 17 |

TABLE 4
Summary of MD 1% sec Modulus of the 3-Layer Films of Table 1

| Value | EMI | EM2 | EM3 |
|---|---|---|---|
| MD 1% sec Modulus (MPa) | 359 | 304 | 346 |

This experiment demonstrates that the polyethylene blend of 75 wt % EXCEED XP™ 8358 and 25 wt % of the ethylene-butene plastomer EXACT™ 9182 can be used to make the sealing layer and provide lower SIT and higher 1% secant modulus in comparison to the polyethylene blend of 75 wt % EXCEED XP™ 6026 or 6056 and the ethylene-butene copolymer plastomer EXACT™ 9182. Furthermore, this discovery teaches us that EXCEED X™ 8358 and plastomer EXACT™ 9182 has synergy to achieve lower SIT at the same time keep higher modulus.

### Example II

In this example, mono-layer film samples having 3 different gauges (film thickness) 25 μm, 50 μm, and 100 μm were produced on an Alpine mono-layer blown line with die gap 1.5 mm and die diameter 160 mm under normal processing conditions. For the sealing layer of the films, the polyethylene composition, EXCEED XP™ 8656 was blended with the ethylene-octene plastomer AFFINITY 1880G under three different blending ratios (see Table 5).

TABLE 5
Blending Ratio

| | Ratio 1 | Ratio 2 | Ratio 3 | Ratio 4 | Ratio 5 |
|---|---|---|---|---|---|
| Exceed 8656 | 0% | 20% | 50% | 80% | 100% |
| Affinity | 100% | 80% | 50% | 20% | 0% |
| 1880G | | | | | |

TABLE 6
Materials Information

| | MI (g/10 min. | |
|---|---|---|
| Material | 2.16 kg/190 C | Density (g/cm³) |
| Exceed XP 8656ML | 0.5 | 0.916 |
| Affinity 1880G | 1.0 | 0.902 |

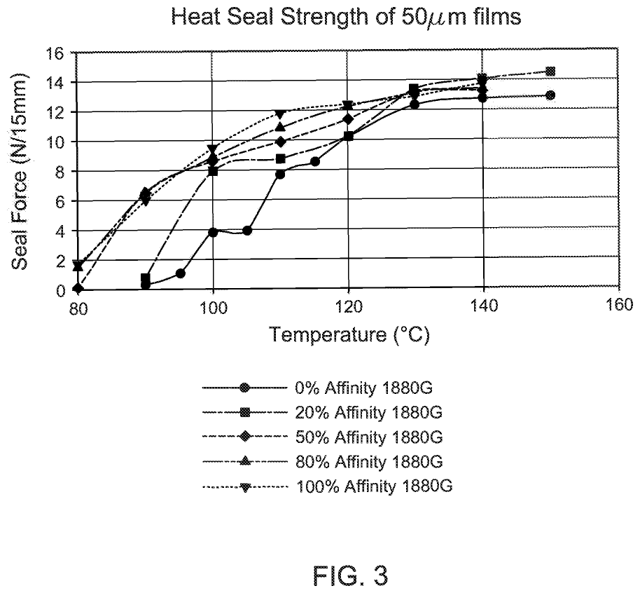

As shown in FIG. 3, the polyethylene blend can comprise up to 50 wt % of the polyethylene composition (EXCEED XP™ 8656) and blended with the ethylene-octene Plastomer (AFFINITY 1880G) without influencing or affecting the heat seal behavior of the 50 micron film samples. Each of the film samples of Table 1 had similar plateau seal strength when compared to the ethylene-octene plastomer AFFINITY 1880G. After adding up to 50 wt % of the polyethylene composition, EXCEED XP™ 8656, the total density of the polyethylene blend was 0.909 g/cm³ which is much higher than the pure Affinity 1880G; however, SIT (@ 5.0 N/15 mm was maintained at 87-88° C. without obvious increase.

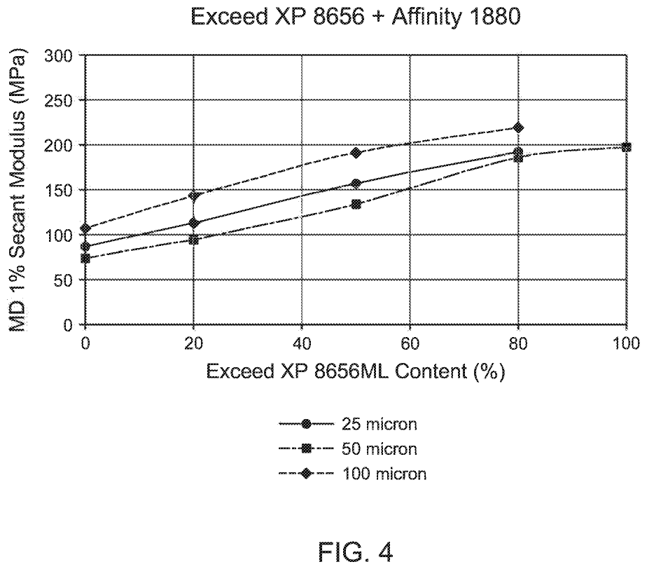

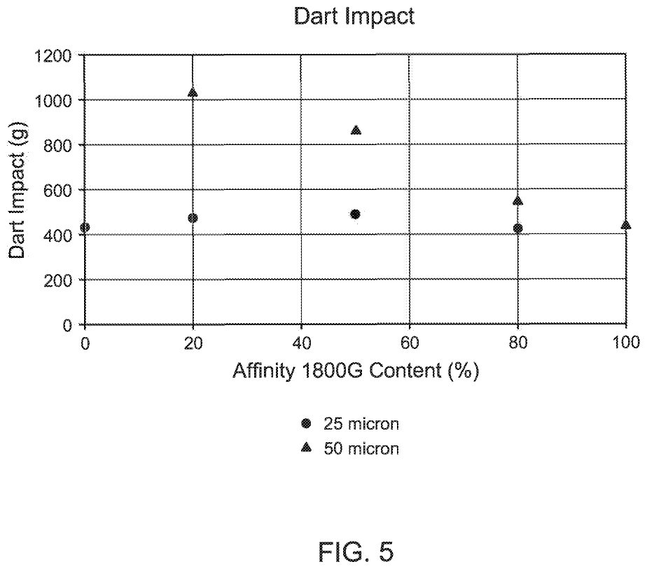

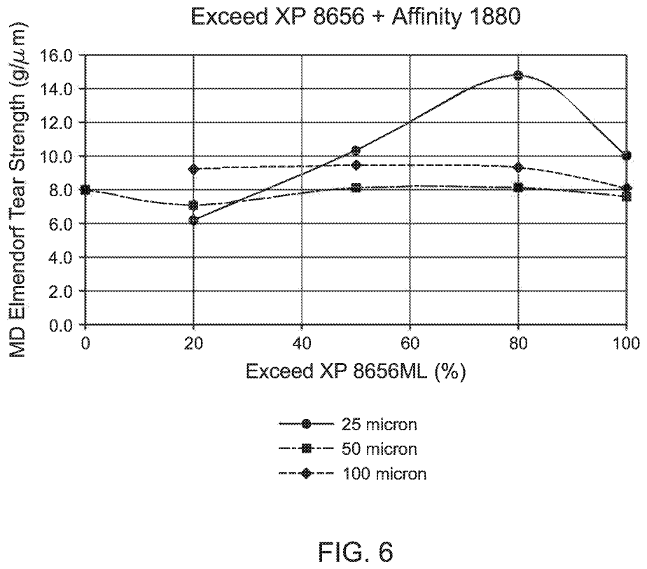

Furthermore, the data represented in FIGS. 4, 5 and 6 shows the MD 1% secant modulus, dart impact, and MD tear of these monolayer film having different blending ratios and film thicknesses, respectively. By increasing of the polyethylene composition (EXCEED XP™ 8656), the MD 1% secant modulus increased linearly due to the increase of overall film density. This is consistent with the general understanding that 1% secant modulus of PE film has linear relationship with the film density. However, we found that dart impact and MD Elmendorf tear were also improved or maintained at the same level which is different from the typical understanding that blending higher density polyethylene composition with plastomer will deteriorate film toughness in terms of dart impact and tear strength.

In this study, we uncovered that polyethylene blends comprising a polyethylene composition with an ethylene-octene plastomer within certain ratios (no more than 50%) can achieve higher 1% secant modulus, higher dart impact and higher MD tear strength, while maintaining SIT. This discovery provides the use of polyethylene compositions to replace at least part of the plastomer and achieve same sealing performance with better mechanical properties when compared to the pure plastomer, resulting in a more economical way for customers who requires high sealing performance of the films.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. A film comprising a core layer sandwiched between an outer layer and a sealing layer, wherein the sealing layer comprises a polyethylene blend, the polyethylene blend comprises a polyethylene composition in an amount from 0% to 100% and a plastomer, and the film has a seal initiation temperature at 5.0 N/15 mm between about 75° C. and about 120° C., a 1% secant modulus in MD between about 50 MPa and about 550 MPa and plateau seal strength at between about 10 and about 20 N/15 mm.

2. The film of claim 1, wherein the polyethylene composition has a density between about 0.912 g/cm³ and about 0.930 g/cm³ and an MI (I₂) between about 0.2 g/10 min and about 5 g/10 min.

3. The film of claim 1, wherein the plastomer is an ethylene alpha olefin copolymer solution.

4. The film of claim 3, wherein the alpha olefin copolymer is selected from the group consisting of 1-butene, 1-hexene, and 1-octene.

5. The film of claim 1, wherein the film has a layer ratio from 1/2/1 to 1/8/1.

6. The film of claim 1, wherein the outer or core layer comprises a polyethylene composition having a density of about 0.918 to about 0.940 g/cm³ and an MI (I₂) of about 0.2 to about 3 g/10 min.

7. The film of claim 1, wherein the sealing layer has a seal initiation temperature at 5.0 N/15 mm between about 82° C. and about 115° C.

8. The film of claim 1, wherein the sealing layer has a thickness between about 25 microns and about 150 microns.

9. The sealing layer of claim 1, wherein the sealing layer has a thickness between about 6 and about 50 microns.

10. A film comprising a polyethylene blend, the polyethylene blend comprising a plastomer and a polyethylene composition having a density between about 0.914 and about 0.920 g/cm³ and a MI of between about 0.5 and about 2.0 g/10 min in an amount equal or less than about 50 wt %, wherein the polyethylene blend has a density between about 0.88 and about 0.91 g/cm³ and the film has a seal initiation temperature at 5N of about 80° C. to about 110° C.

11. The film of claim 10, wherein the blend comprises 20 wt % to 80 wt % of the polyethylene composition, on the basis of weight of the blend; further wherein the polyethylene composition has a density between about 0.916 and about 0.918 g/cm³ and a MI between about 0.2 and about 1 g/10 min; and further wherein the film has an MD 1% secant modulus between about 60 MPa and 250 MPa.

12. The film of claim 10, wherein the blend comprises 20 wt % to 80 wt % of the plastomer, on the basis of weight of the blend; further wherein the polyethylene composition has a density between about 0.916 and about 0.918 g/cm³ and a MI of between about 0.2 and about 1 g/10 min; and further wherein the film has a dart impact between about 400 grams and about 1500 grams.

13. The film of claim 10, wherein the plastomer is a metallocene catalyzed ethylene-octene copolymer; further wherein the polyethylene composition has a density between about 0.916 and about 0.918 g/cm³ and a MI between about 0.2 g/10 min and about 1 g/10; and further wherein the film has an MD Elmendorf tear strength of between about 3 g/μm and about 18 g/μm.

14. The film of claim 10, wherein the film has one or more of the following properties:
(a) 1% secant modulus in MD between about 60 MPa and about 500 MPa;
(b) a dart impact between about 100 g and about 2,000 g; and
(c) an Elmendorf tear in MD between about 2 g/micron and about 18 g/micron.

15. The film of claim 14, having all of the properties (a)-(c).
